(19) United States
(12) Patent Application Publication
(10) Pub. No.: US 2008/0071869 A1
(43) Pub. Date: Mar. 20, 2008

(54) SYSTEM AND METHOD FOR PREEMPTING A USER'S ACTIVITY STATE IN INSTANT MESSAGING SYSTEMS

(75) Inventors: Cynthia E. Barber-Mingo, Westford, MA (US); Cora Clerkin, Drogheda (IE); Gary Denner, Celbridge (IE); Patrick J O'Sullivan, Ballsbridge (IE); Sonya Purcell, Cashel (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,395

(22) Filed: Sep. 20, 2006

(51) Int. Cl. G06F 15/16

(52) U.S. Cl. 709/206; 568/442; 709/203

(57) ABSTRACT

A system and method for preempting a user's activity state in instant messaging (IM). The system includes a server node configured to administer an IM application. At least one client node is operably associated via a network to the server node. The at least one client node is configured to receive and transmit instant messages via the IM application. The client node permits a user to do at least one of, (i) enable a user about to go offline alert signal or (ii) disable a previously set user about to go offline alert signal.

### TRADEMARKS

IBM® is a registered trademark of International Business Machines Corporation, Amonk, N.Y., U.S.A. Other names used herein may be registered trademarks, trademarks or produce names of International Business Machines Corporation or other companies.

### BACKGROUND OF THE INVENTION

1. Field of Invention

This invention relates in general to communication, and more particularly to instant messaging communication.

2. Description of Background

The current art of instant messaging (IM) provides basic awareness features. These features indicate to other peers in the community the following status of a user: active/present, away/idle, offline, do not disturb, back in a minute, etc. However, there is one status missing from current IM art. The missing status is there is no status that allows other peers to see when a user is due/planning to go offline or go away. Currently, if a user logs off or goes away from the IM session for any reason their status changes to offline/away in an instant. This happens without any prior warning to anyone else in the IM session. It is currently impossible to tell when a user is about to go offline. This spontaneity has many drawbacks for others in the community.

Thus, there is a need for a status to allow other peers to see when a user is due/planning to go offline or go away from an IM session.

### SUMMARY OF THE INVENTION

The shortcomings of the prior art are overcome and additional advantages are provided through the provision of a system for preempting a user's activity state in instant messaging (IM). The system includes a server node configured to administer an IM application. At least one client node is operably associated via a network with the server node. The at least one client node is configured to receive and transmit instant messages via the IM application. The client node permits a user to do at least one of, (i) enable a user about to go offline alert signal and, (ii) disable a previously set user about to go offline alert signal.

The shortcomings of the prior art are overcome and additional advantages are provided through the provision of a method for preempting a user's activity state in instant messaging (IM). The method including administering an IM application via a server node. Then receiving and transmitting instant messages via a client node by way of the IM application. Then selecting at least one of (i) enable a user about to go offline alert signal and (ii) disable a previously set user about to go offline alert signal.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a system and a method for preempting a user's activity state to instant messaging (IM).

### BRIEF DESCRIPTION OF THE DRAWINGS

the subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for preempting a user's activity state in instant messaging;

FIG. 2 illustrates one example of a preferences option selection menu from the system shown in FIG. 1; and

FIG. 3 illustrates one example of a method for preempting a user's activity state in instant messaging.

The detailed description explains an exemplary embodiment of the invention, together with advantages and features, by way of example with reference to the drawings.

### DETAILED DESCRIPTION OF THE INVENTION

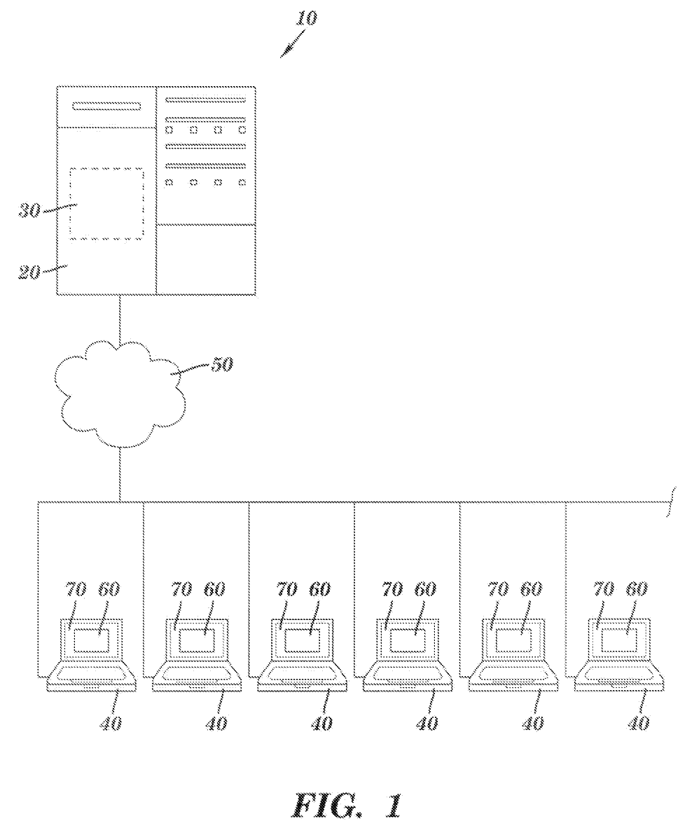

Referring to FIG. 1, a system 10 for preempting a user's activity state in instant messaging (IM), is shown. The system 10 includes a server node 20, the server node 20 is configured to administer an IM application 30 located on the server node 20.

At least one client node 40 is operably associated via a network 50 with the server node 20. The client node 40 is configured to receive and transmit instant messages via the IM application 30. The client node 40 permits a user to do at least one of (i) enable a user about to go offline alert signal and, (ii) disable a previously set user about to go offline alert signal.

When the user about to go offline signal is set, the user will receive on their client node 40 an electronic notification message that their status is about to change prior to the user going offline. The user about to go offline alert signal may be viewed by others. Furthermore, the user about to go offline alert signal may be managed by an administrator such that the administrator may flag to users when they are due to be taken offline. When the user about to go offline alert signal is set, the signal acts as a reminder to the user pending a status change that the user is near the end of the user's allotted time.

When the user's calendar is marked as busy for a designated period the going offline status becomes active for a period of time prior to the event. Furthermore, when the user is limited to x amount of time, towards the end of the IM session the user's status will change to going offline.

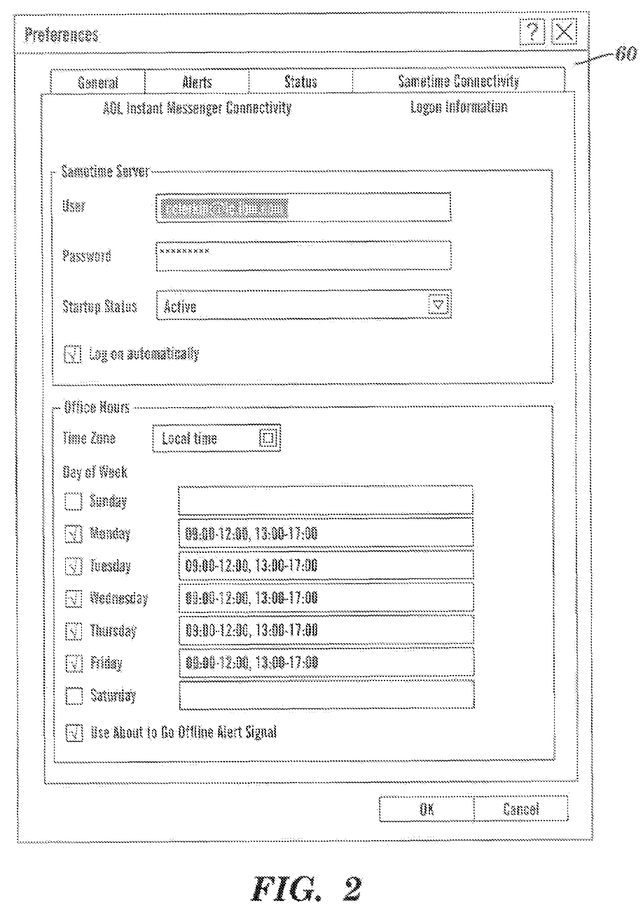

Referring to FIGS. 1 and 2, the user about to go offline alert signal is accessible via a user preferences option selection menu 60. The user preference option selection menu 60 is accessible via a user interface (UI) 70 displayed on the client node 40. The UI 70 is configured to allow the user to review, draft, receive and transmit instant messages via the system 10. The user may activate an icon on the UI 70 that indicates what the user is about to go offline to do.

The user preferences option selection menu 60 allows the user to specify the user's office hours. The user preferences option selection menu 60 allows the user to show how long the user shall be offline. Furthermore, the user preferences option selection menu 60 allows the user to show in minutes how long the user will be gone offline.

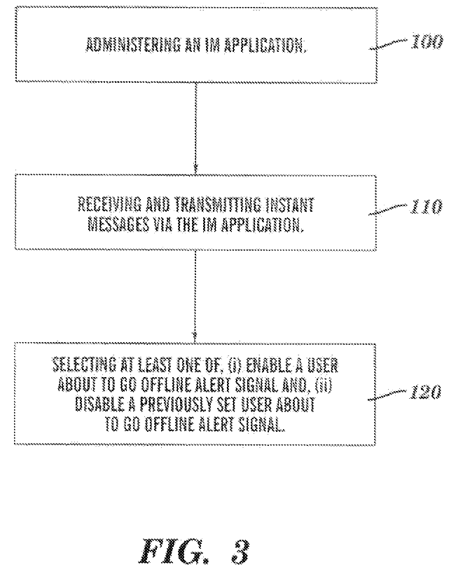

Referring to FIG. 3, a method for preempting a user's activity state in instant messaging (IM), is shown. Starting at step 100, an IM application is administered via a server node. At step 110, instant messages are received and transmitted via a client node by way of the IM application. In conclusion at step 120, the user selects at least one of, (i) to enable a user about to go offline alert signal and, (ii) to disable a previously set user about to go offline alert signal.

When the user about to go offline alert signal is set, the user will receive a notification message that their status is about to change prior to the user going offline. The user about to go offline alert signal may be viewed by others. The user about to go offline alert signal is accessible via a user preference options selection menu.

The user preference option selection menu is accessible via a user interface (UI) on the client node. The UI is configured to allow the user to review, draft, receive and transmit instant messages. The user preference option selection menu allows the user to specify the user's office hours. The user about to go offline alert signal may be managed by an administrator such that the administrator may flag to users when they are due to be taken offline.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for preempting a user's activity state in instant messaging (IM), comprising:
a server node configured to administer the IM application;
at least one client node operably associated via a network with the server node, the at least one client node being configured to receive and transmit instant messages via the IM application; and
wherein the client node permits a user to do at least one of (i) enable a user about to go offline alert signal and, (ii) disable a previously set user about to go offline alert signal.

2. The system of claim 1, wherein when the user about to go offline alert signal is set, the user will receive a notification message that their status is about to change prior to the user going offline.

3. The system of claim 2, wherein the user abut to go offline alert signal may be viewed by others.

4. The system of claim 3, wherein the user about to go offline alert signal is accessible via a user preferences option selection menu.

5. The system of claim 4, wherein the user preferences option selection menu is accessible via a user interface (UI) on the client node, the UI is configured to allow the user to review, draft, receive and transmit instant messages.

6. The system of claim 5, wherein the user preferences option selection menu allows the user to specify the user's office hours.

7. The system of claim 6, wherein the user about to go offline alert signal may be managed by an administrator such that the administrator may flag to users when they are due to be taken offline.

8. The system of claim 7, wherein when the user about to go offline alert signal is set, the signal acts as a reminder to the user pending a status change that the user is near the end of the user's allotted time.

9. The system of claim 8, wherein when the user's calendar is marked as busy for a designated period the going offline status becomes active for a period of time prior to the event.

10. The system of claim 9, wherein when the user is limited to x amount of time, towards the end of the IM session the user's status will change to going offline.

11. The system of claim 10, wherein the UI includes an icon that enhances what the user is about to go offline to do.

12. The system of claim 11, wherein the user preferences option selection menu allows the user to show how long the user shall be offline.

13. The system of claim 12, wherein the user preferences option selection menu allows the user to show in minutes how long the user will be gone offline.

14. A method for preempting a user's activity state in instant messaging (IM), comprising:
administering an IM application via a server node;
receiving and transmitting instant messages via a client node by way of the IM application; and
selecting at least one of, (i) enable a user about to go offline alert signal and, (ii) disable a previously set user about to go offline alert signal.

15. The method of claim 14, wherein when the user about to go offline alert signal is set, the user will receive a notification message that their status is about to change prior to the user going offline.

16. The method of claim 15, wherein the user about to go offline alert signal may be viewed by others.

17. The method of claim 16, wherein the user about to offline alert signal is accessible via a user preferences option selection menu.

18. The method of claim 17, wherein the user preferences option selection menu is accessible via a user interface (UI) on the client node, the UI is configured to allow the user to review, draft, receive and transmit instant messages.

19. The method of claim 18, wherein the user preferences option selection menu allows the user to specify the user's office hours.

20. The method of claim 16, wherein the user about to go offline alert signal may be managed by an administrator such that the administrator may flag to users when they are due to be taken offline.
